(19) United States
(12) Patent Application Publication
(10) Pub. No.: US 2017/0175394 A1
(43) Pub. Date: Jun. 22, 2017

(54) PLANT GROWTH MEDIA

(71) Applicant: BOARD OF REGENTS, THE UNIVERSITY OF TEXAS SYSTEM, Austin, TX (US)

(72) Inventor: Mark T. Simmons, Austin, TX (US)

(21) Appl. No.: 15/124,730

(22) PCT Filed: Mar. 18, 2015
(86) PCT No.: PCT/US15/21232

§ 371 Date: Sep. 9, 2016

Related U.S. Application Data
(60) Provisional application No. 61/954,933, filed on Mar. 18, 2014.

(51) Int. Cl. E04D 11/00; A01G 1/00; E04D 1/08; C05F 9/04; E04C 2/28; E04C 2/04; C05F 11/02; C05G 3/04; E04D 11/02; E04C 2/16

(52) U.S. Cl. CPC E04D 11/002; E04D 11/02; A01G 1/007; A01G 1/005; E04D 1/085; E04C 2/16; E04C 2/28; E04C 2/04; C05F 11/02; C05G 3/04; C05F 9/04; Y02B 80/32

(57) ABSTRACT

The present invention includes a material and method of installing a construction material for dry or arid climates, comprising: a growth media comprising an abiotic porous material and activated charcoal such as biochar; and at least one of a compost, grain hulls and nut shells, wherein plants in the material are able to survive without exogenous water for use in areas comprising at least one of Aw, BS, BW, Csa, Csb, Ds or Dw climates according to the Koppen-Geiger climate classification.

### TECHNICAL FIELD OF THE INVENTION

The present invention relates in general to the field of growth media for growing plants, and more particularly, to a novel construction material for the sustainable growth of plants in harsh environments.

### BACKGROUND OF THE INVENTION

Without limiting the scope of the invention, its background is described in connection with vegetated roof systems.

U.S. Pat. No. 8,516,744, issued to Dubner, is entitled “Modular Interlocking Pre-vegetated Roof System.” Briefly, this inventor teaches a modular unit, system and method that include a base layer having a plurality of reservoirs configured to prevent water flow through a lower portion, the lower portion for contacting a support surface, and having interlocking portions configured to interlock adjacent base layers when installed. A water permeable layer is said to be disposed over the base layer. A detachable wall is mountable on the base layer to contain planting media. Finally, the water permeable layer may include a water-holding capillary fabric mat layer with entangled filaments.

Another system is taught in U.S. Pat. No. 7,805,885, issued to Luckett entitled, “Green Roof Planter.” Briefly, this inventor teaches a roof planter comprising a body capable of placement upon a roof, a pad in association with the body, growth medium, and vegetation in association with the growth medium. The pad is said to be composed of a material that is compatible with the surface of the roof, and is positioned between the body and the roof, the body retaining the growth medium when the roof planter is placed upon a roof Finally, the roof planters are configured so as to enable the nesting of one roof planter within another.

United States Patent Application Publication No. 2012/0227319, filed by Jaslow is entitled “Modular Green Roof System.” Briefly, this applicant is said to teach an improved modular green roof system for installation on a roof includes: (a) trays, each having a surface chosen from the group of sidewall, bottom and a combination of such surfaces, and having drainage openings that limit the movement of planting media through the surface while promoting maximum root growth and water and moisture transport through the surface, (b) a water management passage, (c) a structural member that extends across each of the trays and attaches to the opposing bottom sidewall to provide rigidity to each tray, (d) locking members for use with the trays, and wherein each of the trays have a locking opening configured to accommodate one of the locking members, (e) stacking members for use with the trays, and wherein each of the trays have a stacking opening configured to accommodate the insertion of one the stacking members, (f) a slope stabilization device, a portion of which is configured to be accommodated in water management passages, and (g) a water retention medium configured for placement below and in direct contact with the tray's bottom surface.

A number of websites and other publications are directed to green roofs and walls such as: roofmeadow.wordpress.com/category/green-roofs-horticulture-green-infrastructure; www.hhydro.com/pbh-rice-hulls.html; and GREEN ROOFS IN SUSTAINABLE LANDSCAPE DESIGN, by Steven L Cantor, New York, N.Y., W.W. Norton & Co., ©2008.

### SUMMARY OF THE INVENTION

The present invention includes, in one embodiment, a construction material for dry or arid climates, comprising: a growth media comprising an abiotic porous material and activated charcoal such as biochar; and at least one of a compost, grain hulls and nut shells, wherein plants in the material are able to survive without exogenous water for use in areas comprising at least one of Aw, BS, BW, Csa, Csb, Ds or Dw climates according to the Koppen-Geiger climate classification. In one aspect, the material is uncompressed, semi-compressed, formed into trays, formed into bricks, compressed into a layer, formed into spheres or balls, formed into pellets, or formed into a monolayer. In another aspect, the abiotic porous material is selected from at least one of expanded shale, clay, brick, or lava. In another aspect, the compost is selected from at least one of organic compost, exhibiting low nitrogen, or low phosphorous. In another aspect, the nut shell may be selected from at least one of pecan shells, walnut shells, peanut shells, almond shells, pistachio shells, or hazelnut shells. In another aspect, the grain hull is selected from at least one of rice hulls, corn hulls, wheat hulls, sorghum hulls, or rye hulls. In another aspect, the activated charcoal is a biochar, which biochar can be selected from at least one of rice hull ash, corn hull ash, wheat hull ash, or sorghum hull ash, or other forms of biochar.

In another aspect, the growth media comprises between 40, 45, 50, 55, 60, 65, 40 to 70, 45 to 65, or 50 to 60 percent by volume of the material. In another aspect, the compost comprises between 5, 12.5, 15, 17.5, 20, 22.5, 5 to 25, 12.5 to 22.5, or 15 to 20 percent by volume of the material. In another aspect, the nut shells comprise between 1, 2, 3, 4, 5, 6, 7, 8, 9, 10, 11, 12.5, 15, 17.5, 20, 22.5, 5 to 25, 12.5 to 22.5, or 15 to 20, or 0 to 25 percent by volume of the material. In another aspect, the grain hulls comprise between 5, 12.5, 15, 17.5, 20, 22.5, 5 to 25, 12.5 to 22.5, or 15 to 20 percent by volume of the material. In another aspect, the biochar comprises between 5, 12.5, 15, 17.5, 20, 22.5, 5 to 25, 12.5 to 22.5, or 15 to 20 percent by volume of the material. In another aspect, the material further comprises at least one water-pervious layer placed between the material and the roof. In another aspect, all the materials are recycled. In another aspect, the growth media may be obtained from growers or producers that are local to the site of manufacture. In another aspect, the material has the following characteristics:

| Characteristic | Units | Range |
|---|---|---|
| Permeability (saturated hydraulic | mm/min | 10-50 |
| conductivity) | | |
| Dry media density (application density) | g/cm³ | 0.6-1.5 |
| Media density (application density) | g/cm³ | 0.8-1.5 |
| Max media density (saturated density) | g/cm³ | 0.8-1.5 |
| Max water retention | % | 25-70 |
| Total pore space | % | 30-70 |
| Air-filled porosity | % | 5-70 |
| pH | | 5.8-8.5 |
| Gravel (9.5 mm) | % | 50-95 |
| Gravel (3.1 mm) | % | 10-95 |
| Very coarse (1.0 mm) | % | 5-50 |
| Medium (0.25 mm) | % | 2-40 and |
| Very fine (0.063 mm) | % | 2-40. |

Another embodiment of the present invention includes a method of making a vegetated roof system, comprising: identifying a roof in need of a vegetated roof system; positioning on at least a portion of the roof with materials comprising: an abiotic porous material and a biochar; and at least one of a compost, grain hulls, or nut shells, wherein plants capable of growing in the material are able to survive without exogenous water for use in a areas comprising at least one of Aw, BS, BW, Csa, Csb, Ds or Dw climates according to the Koppen-Geiger climate classification. In another aspect, the material is uncompressed, semi-compressed, formed into trays, formed into bricks, compressed into a layer, formed into spheres or balls, formed into pellets, or formed into a monolayer. In another aspect, the growth media is selected from at least one of expanded shale, clay, brick, or lava, or other abiotic porous material. In another aspect, the compost is selected from at least one of organic compost, vegan compost, low nitrogen, or low phosphorous. In another aspect, the nut shell is selected from at least one of pecan shells, walnut shells, peanut shells, almond shells, pistachio shells or hazelnut shells. In another aspect, the grain hull is selected from at least one of rice hulls, corn hulls, wheat hulls, sorghum hulls, or rye hulls. In another aspect, the biochar is selected from at least one of rice hull ash, corn hull ash, wheat hull ash, or sorghum hull ash, or other forms of biochar.

In another aspect, the growth media comprises between 40, 45, 50, 55, 60, 65, 40 to 70, 45 to 65, or 50 to 60 percent by volume of the material. In another aspect, the compost comprises between 5, 12.5, 15, 17.5, 20, 22.5, 5 to 25, 12.5 to 22.5, or 15 to 20 percent by volume of the material. In another aspect, the nut shells comprise between 1, 2, 3, 4, 5, 6, 7, 8, 9, 10, 11, 12.5, 15, 17.5, 20, 22.5, 5 to 25, 12.5 to 22.5, or 15 to 20, or 0 to 25 percent by volume of the material. In another aspect, the grain hulls comprise between 5, 12.5, 15, 17.5, 20, 22.5, 5 to 25, 12.5 to 22.5, or 15 to 20 percent by volume of the material. In another aspect, the biochar comprises between 5, 12.5, 15, 17.5, 20, 22.5, 5 to 25, 12.5 to 22.5, or 15 to 20 percent by volume of the material. In another aspect, the material further comprises at least one water-pervious layer placed between the material and the roof In another aspect, all the materials are recycled. In another aspect, the material has the following characteristics:

| Characteristic | Units | Range |
|---|---|---|
| Permeability (saturated hydraulic | mm/min | 10-50 |
| conductivity) | | |
| Dry media density (application density) | g/cm³ | 0.6-1.5 |
| Media density (application density) | g/cm³ | 0.8-1.5 |
| Max media density (saturated density) | g/cm³ | 0.8-1.5 |
| Max water retention | % | 25-70 |
| Total pore space | % | 30-70 |
| Air-filled porosity | % | 5-70 |
| pH | | 5.8-8.5 |
| Gravel (9.5 mm) | % | 50-95 |
| Gravel (3.1 mm) | % | 10-95 |
| Very coarse (1.0 mm) | % | 5-50 |
| Medium (0.25 mm) | % | 2-40 and |
| Very fine (0.063 mm) | % | 2-40. |

In another aspect, the material has the following characteristics: Yet another embodiment of the present invention includes a self sustaining roofing material for roofs, comprising: an abiotic porous material at between 40 to 70 volume percent; a compost at between 5 to 25 volume percent; grain hulls at between 5 to 20 volume percent and biochar at between 5 to 20 volume percent, wherein plants in the material are able to survive without exogenous water for use in a areas comprising a Aw, BS, BW, Csa, Csb, Ds or Dw climate according to the Koppen-Geiger climate classification.

### BRIEF DESCRIPTION OF THE DRAWINGS

None.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

As used herein, the term “growth medium” refers to an abiotic porous material for use with the present invention. In certain instances the growth media can also be referred to as a substrate. The present invention generally requires two basic components, a growth medium and a form of activated charcoal such as a biochar. In addition, the construction material of the present invention can also include one or more of the following: compost, shells and/or hulls. As used herein, the skilled artisan will recognize that certain materials can be combined based on their weight percent, or their volume percent, which can be interchanged knowing the density of the material.

As used herein, the term “compost” refers to an at least partially organic matter, e.g., plant material and food waste, that has been decomposed into humus for a period of weeks, months, or years (such as 1-2 years), and used as a fertilizer and/or soil amendment.

As used herein, climates for use of the present invention follow the “Koppen” or “Koppen-Geiger” climate classification system. Other such systems can also be used based on the following parameters. As demonstrated herein below, the material of the present invention will find particular used as a green roof media where one or both of the following characterize the climate: (a) extended periods of dryness; and (b) heavy storm water events. While the material can be used in any climate, it will find particularly uses (but not necessarily exclusive uses) in at least the following climate zones: Aw—tropical moist (dry summer); BS—semiarid; BW—arid; Csa—Dry summer, cool winter (Mediterranean); Csb; Ds continental with dry season; and/or Dw. The skilled artisan will understand that climate zones will vary over time, especially in the light of climatic changes, where more climate zones are expected to experience more climatic stochasticity—drought floods.

As used herein, the term “biochar” refers to charcoal that is used as a soil amendment, e.g., biomass that is made into charcoal created by pyrolysis (artificially or naturally). Generally, but in no way a limitation of the present invention, biochar can be used to improve water retention, reduce nutrient leaching, reduce soil acidity, reduce irrigation, and act as a fertilizer.

As used herein, the term “nut shells” refer to those shells or other plant materials that take more than one year to completely decompose into organic matter such that is visually difficult to identify the parent material. Non-limiting examples of nuts that can provide their shells include pecan, walnut, peanut, almond, pistachios, hazelnuts or other locally available nuts.

As used herein, the term “hulls” or “husks” are used interchangeably to refer to the outer coating or shell (commonly dry) of a seed, grain, fruit or nut. Non-limiting examples of hulls for use with the present invention include rice, corn, wheat, sorghum, rye or other hulls. For use with the invention, the type of hull or hulls will preferably obtained from the local region in which the present invention is produced based on the locally available types of seed, grain, fruit or nuts.

Although historically green (vegetated) roof systems have been found in different regions across Europe and Asia, the development of the contemporary extensive green roof has largely been in the temperate and cool-temperate climates of Europe and North America. Although periods of heat and drought can and do impact these regions, compared to tropical and subtropical zones the climates can generally be described as being characterized by moderate rainfall spread across the year (drought notwithstanding), cool or cold winters mild to warm summers and moderate diurnal temperate variation. Regardless of climate green roof microclimate can generally be described as less benign than normal landscape conditions due to decreased moisture availability from lower roost volumes and growing media characteristics, periods of drought, high temperatures, and higher wind velocities. All creating a somewhat hostile environment for plant growth.

Translating this technology to Mediterranean, sub-tropical and tropical regions (henceforth “hot climates”) presents a challenging suite of climate problems including: flash flooding, prolonged drought, high day and night-time air and soil temperatures and limited available water supply. Ironically, green roofs in these warmer environments might be more justified as a necessary green technology by providing mitigation performance across multiple scales for some of the very characteristics of (storm water, heat island effect) which threaten them. This new green roof growing media product is intended to facilitate the implementation of green roof technology in hot climates.

The present invention overcomes one or more of the following limitations to existing technology, including: (1) Increasing plant water availability; (2) decreasing growing media temperature and hence root temperature; (3) using material which have properties similar to organic matter but which have longevity on the roof; (4) using a material that has high recycled content (to meet LEED standards); and (5) lightweight.

The first two are linked as decreasing temperature increases water retention. The main problem from a thermal conductivity perspective is minimizing it without compromising water holding capacity. This is achieved by using a number of components which result in a broad spread particle sizes and using materials which have ability to absorb water to improve storm water retention and slowing release this (to plants) over time. Additionally the three of the four organic components either degrade very slowing over time, with the two rice by-products having an indefinite life-time due to high silica and/or black carbon content.

TABLE 1
SkySystem Growing Media characteristics (with crushed brick).

| | | As | |
|---|---|---|---|
| Characteristics | Units | measured | Range |
| Permeability (saturated hydraulic | mm/min | 17.2 | 10-50 |
| conductivity) | | | |
| Dry media density (application | g/cm³ | 0.96 | 0.6-1.5 |
| density) | | | |
| Media density (application density) | g/cm³ | 1.06 | 0.8-1.5 |
| Max media density (saturated | g/cm³ | 1.39 | 0.8-1.5 |
| density) | | | |
| Max water retention | % | 44 | 25-70 |
| Total pore space | % | 59 | 30-70 |
| Air-filled porosity | % | 15 | 5-70 |
| pH | | 6.2 | 5.8-8.5 |
| Gravel (9.5 mm) | % | 93.8 | 50-95 |
| Gravel (3.1 mm) | % | 26.2 | 10-95 |
| Very coarse (1.0 mm) | % | 18.0 | 5-50 |
| Medium (0.25 mm) | % | 11.9 | 2-40 |
| Very fine (0.063 mm) | % | 7.7 | 2-40 |

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of”. As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step or a limitation) or group of integers (e.g., feature(s), element(s), characteristic(s), propertie(s), method/process steps or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

1. A construction material for dry or arid climates, comprising:
a growth media comprising an abiotic porous material and activated charcoal; and
at least one of a compost, grain hulls, or nut shells,
wherein plants in the construction material are able to survive without exogenous water for use in areas comprising at least one of Aw, BS, BW, Csa, Csb, Ds or Dw climates according to the Koppen-Geiger climate classification.

2. The construction material of claim 1, wherein the construction material is uncompressed, semi-compressed, formed into trays, formed into bricks, compressed into a layer, formed into spheres or balls, formed into pellets, or formed into a monolayer.

3. The construction material of claim 1, wherein the abiotic porous material is selected from at least one of expanded shale, clay, brick, or lava.

4. The construction material of claim 1, wherein the compost is selected from at least one of organic compost, vegan compost, low nitrogen compost, or low phosphorous compost.

5. The construction material of claim 1, wherein the nut shell is selected from at least one of pecan shells, walnut shells, peanut shells, almond shells, pistachio shells, or hazelnut shells.

6. The construction material of claim 1, wherein the grain hull is selected from at least one of rice hulls, corn hulls, wheat hulls, sorghum hulls, or rye hulls.

7. The construction material of claim 1, wherein the activated charcoal is a biochar, and the biochar is selected from at least one of rice hull ash, corn hull ash, wheat hull ash, or sorghum hull ash.

8. The construction material of claim 1, wherein the growth media comprises between 40 to 70, 45 to 65, or 50 to 60 percent by volume of the construction material.

9. The construction material of claim 1, wherein the compost comprises between 5 to 25, 12.5 to 22.5, or 15 to 20 percent by volume of the construction material.

10. The construction material of claim 1, wherein the nut shells comprise between 5 to 25, 12.5 to 22.5, or 15 to 20, or 0 to 25 percent by volume of the construction material.

11. The construction material of claim 1, wherein the grain hulls comprise between 5 to 25, 12.5 to 22.5, or 15 to 20 percent by volume of the construction material.

12. The construction material of claim 1, wherein the activated charcoal comprises between 5 to 25, 12.5 to 22.5, or 15 to 20 percent by volume of the construction material.

13. The construction material of claim 1, wherein at least a portion of the construction material is recycled material.

14. The construction material of claim 1, wherein the construction material has the following characteristics:

| Characteristic | Units | Range |
|---|---|---|
| Permeability (saturated hydraulic | mm/min | 10-50 |
| conductivity) | | |
| Dry media density (application density) | g/cm³ | 0.6-1.5 |
| Media density (application density) | g/cm³ | 0.8-1.5 |
| Max media density (saturated density) | g/cm³ | 0.8-1.5 |
| Max water retention | % | 25-70 |
| Total pore space | % | 30-70 |
| Air-filled porosity | % | 5-70 |
| pH | | 5.8-8.5 |
| Gravel (9.5 mm) | % | 50-95 |
| Gravel (3.1 mm) | % | 10-95 |
| Very coarse (1.0 mm) | % | 5-50 |
| Medium (0.25 mm) | % | 2-40 |
| Very fine (0.063 mm) | % | 2-40 |

15. A method of making a vegetated roof system, comprising:
positioning on at least a portion of a roof a construction material comprising: an abiotic porous material and a biochar; and
at least one of a compost, grain hulls, or nut shells, wherein plants capable of growing in the construction material are able to survive without exogenous water for use in a areas comprising at least one of Aw, BS, BW, Csa, Csb, Ds or Dw climates according to the Koppen-Geiger climate classification.

16. The method of claim 15, wherein the construction material is uncompressed, semi-compressed, formed into trays, formed into bricks, compressed into a layer, formed into spheres or balls, formed into pellets, or formed into a monolayer.

17. The method of claim 15, wherein the abiotic porous material is selected from at least one of expanded shale, clay, brick, or lava.

18. The method of claim 15, wherein the compost is selected from at least one of organic compost, low nitrogen compost, or low phosphorous compost.

19. The method of claim 15, wherein the nut shell is selected from at least one of pecan shells, walnut shells, peanut shells, almond shells, pistachio shells, or hazelnut shells.

20. The method of claim 15, wherein the grain hull is selected from at least one of rice hulls, corn hulls, wheat hulls, sorghum hulls, or rye hulls.

21. The method of claim 15, wherein the biochar is selected from at least one of rice hull ash, corn hull ash, wheat hull ash, or sorghum hull ash.

22. The method of claim 15, wherein the growth media comprises between 45 to 65, or 50 to 60 percent by volume of the material.

23. The method of claim 15, wherein the compost comprises between 5 to 25, 12.5 to 22.5, or 15 to 20 percent by volume of the construction material.

24. The method of claim 15, wherein the nut shells comprise between 5 to 25, 12.5 to 22.5, or 15 to 20, or 0 to 25 percent by volume of the construction material.

25. The method of claim 15, wherein the grain hulls comprise between 5 to 20, 12.5 to 20, or 15 to 20 percent by volume of the construction material.

26. The method of claim 15, wherein the biochar comprises between 5 to 20, 12.5 to 20, or 15 to 20 percent by volume of the construction material.

27. The method of claim 15, further comprising placing at least one water-pervious layer between the construction material and the roof.

28. The method of claim 15, wherein at least a portion of the construction material is recycled material.

29. The method of claim 15, wherein the construction material has the following characteristics:

| Characteristic | Units | Range |
|---|---|---|
| Permeability (saturated hydraulic | mm/min | 10-50 |
| conductivity) | | |
| Dry media density (application density) | g/cm³ | 0.6-1.5 |
| Media density (application density) | g/cm³ | 0.8-1.5 |
| Max media density (saturated density) | g/cm³ | 0.8-1.5 |
| Max water retention | % | 25-70 |
| Total pore space | % | 30-70 |
| Air-filled porosity | % | 5-70 |
| pH | | 5.8-8.5 |
| Gravel (9.5 mm) | % | 50-95 |
| Gravel (3.1 mm) | % | 10-95 |
| Very coarse (1.0 mm) | % | 5-50 |
| Medium (0.25 mm) | % | 2-40 and |
| Very fine (0.063 mm) | % | 2-40. |

30. A roofing material, comprising:
an abiotic porous material at between 40 to 70 volume percent; a compost at between 5 to 25 volume percent; grain hulls at between 5 to 20 volume percent, and biochar at between 5 to 20 volume percent, wherein plants in the roofing material are able to survive without exogenous water for use in a areas comprising at least one of Aw, BS, BW, Csa, Csb, Ds or Dw climates according to the Koppen-Geiger climate classification.
